(19) United States
(12) Patent Application Publication
(10) Pub. No.: US 2013/0257731 A1
(43) Pub. Date: Oct. 3, 2013

(54) MOUSE STRUCTURE

(71) Applicant: TSUNG-SHIH LEE, New Taipei City (TW)

(72) Inventor: TSUNG-SHIH LEE, New Taipei City (TW)

(73) Assignee: Cheng Uei Precision Industry Co., LTD., New Taipei City (TW)

(21) Appl. No.: 13/438,816

(22) Filed: Apr. 3, 2012

(51) Int. Cl. G06F 3/033

(52) U.S. Cl. 345/163

(57) ABSTRACT

A mouse structure includes a housing, a sliding apparatus, and a resilient device. The housing has upper and lower walls, an internal space, and an opening communicating with the internal space. The sliding apparatus slidably disposed in the housing has a base portion and a reacting portion having a cover and a bottom board. The resilient device is connected with and disposed between the cover and the bottom board. When the sliding apparatus is in a closed state, the cover is retained by the upper wall of the housing in the internal space, and the resilient device is compressed and deformed by the cover, while the reacting portion moves out of the housing, the resilient device is not compressed, and the cover is automatically pushed outwards by the resilient device so as to position the cover in place.

### BACKGROUND OF THE INVENTION

1. Field of the Invention

The present invention relates to a mouse, and particularly to a mouse structure that is capable of being retractable, automatically positioned in an open state, and less space occupied when not in use.

2. Related Art

Types and shapes of mice are various. Whatever the type or shape is, a conventional mouse has its own physical size which occupies a certain space whenever it is in use or not. Although a mouse can be designed as small size, they are merely suitable for users of smaller palms but not for most users.

Hence, a mouse is improved to have a retracting portion for being retractable into a casing of the mouse to reduce the size when not in use. However, when the retracting portion is moved out of the casing, an upper face of the retracting portion tends to retain an elevation difference with an upper wall of the housing, which causes an inappropriate position of the retracting portion, and is further required to be manually manipulated to align the retracting portion and the casing. Otherwise the retracting portion will be retracted back to the casing while the mouse is in use, and which severely affects the use of the mouse. Furthermore, when the mouse is positioned in a close state, the retracting portion is manipulated with a certain force to move back to the casing, but the process of moving back is difficult and not smooth, and apt to cause the retracting portion to be blocked by the casing. Therefore, it is imperative to overcome the aforesaid drawbacks of the conventional mouse by improving it to be easy to use.

### SUMMARY OF THE INVENTION

Accordingly, an object of the present invention is to provide a mouse structure having a retractable structure capable of being automatically positioned in place in an open state with more compact size.

To achieve the above-mentioned object, a mouse structure of the present invention comprises a housing having upper and lower walls, an internal space defined between the upper and lower walls, and an opening communicating with the internal space; a sliding apparatus slidably disposed in the housing and capable of sliding in and out of the housing from the opening, the sliding apparatus comprising a base portion and a reacting portion, the reacting portion having a cover and a bottom board, the cover being engageable with the bottom board and having a position wall; and a resilient device disposed between the cover and the bottom board.

With the above-mentioned structure, when the sliding apparatus is in a closed state, the cover is retained by the upper wall of the housing in the internal space, and the resilient device is compressed and deformed by the cover, while the reacting portion of the sliding apparatus moves out of the housing, the resilient device is not compressed, and the cover is automatically pushed outwards by the resilient device, whereby the position wall of the cover is propped against the upper wall of the housing, and the sliding apparatus is in an open state.

### BRIEF DESCRIPTION OF THE DRAWINGS

FIG. 1 is a schematic partially assembly view of a mouse structure of the present invention in an open state, with a cover sliding up;

FIG. 2 is a schematic partially assembly view of the mouse structure of FIG. 1 in a closed state, with the cover and an upper wall of a housing being removed;

FIG. 3 is a perspective exploded view showing a sliding apparatus of the mouse structure of the present invention;

FIG. 4 is a right side elevational view of FIG. 1, with the cover positioned in place; and

FIG. 5 is a perspective assembly view of the mouse structure of the present invention;

FIG. 6 is a schematic perspective view of first and second spring elements of the mouse structure of the present invention; and

FIG. 7 is a schematic view showing deforming processes of the first and second spring elements.

### DESCRIPTION OF THE PREFERRED EMBODIMENTS

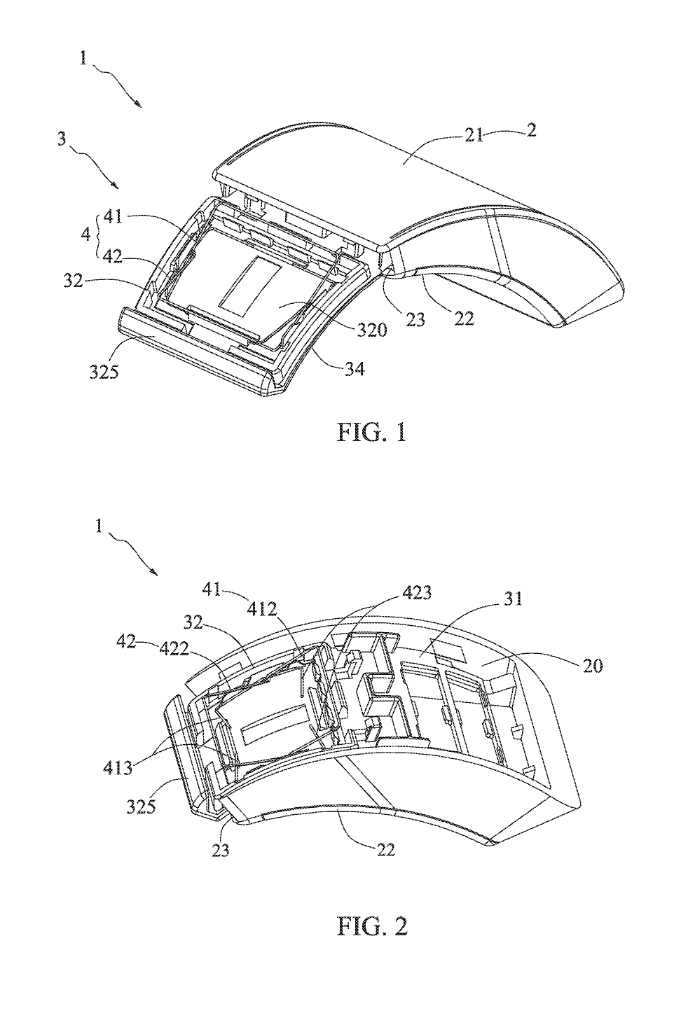

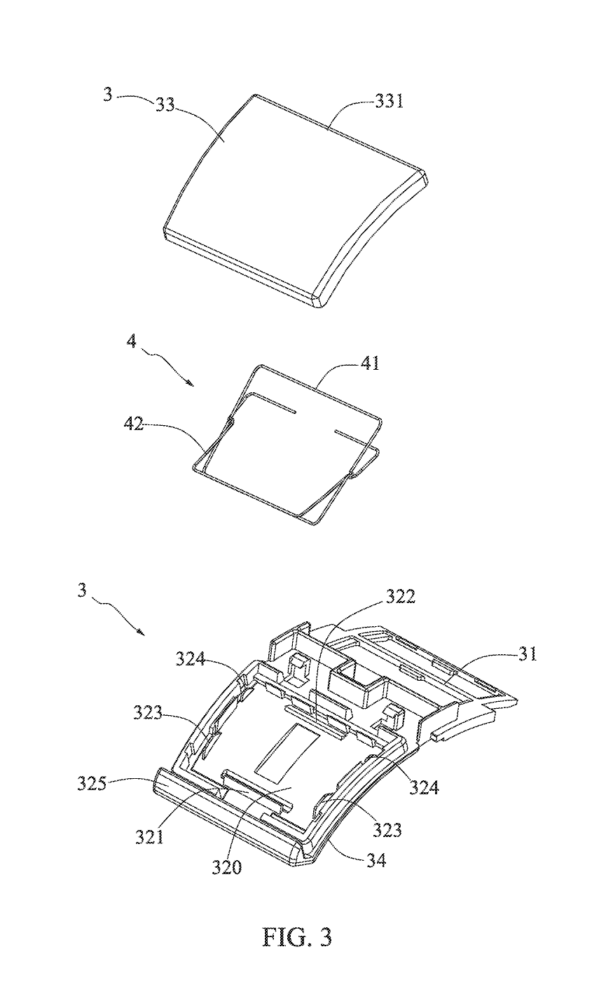

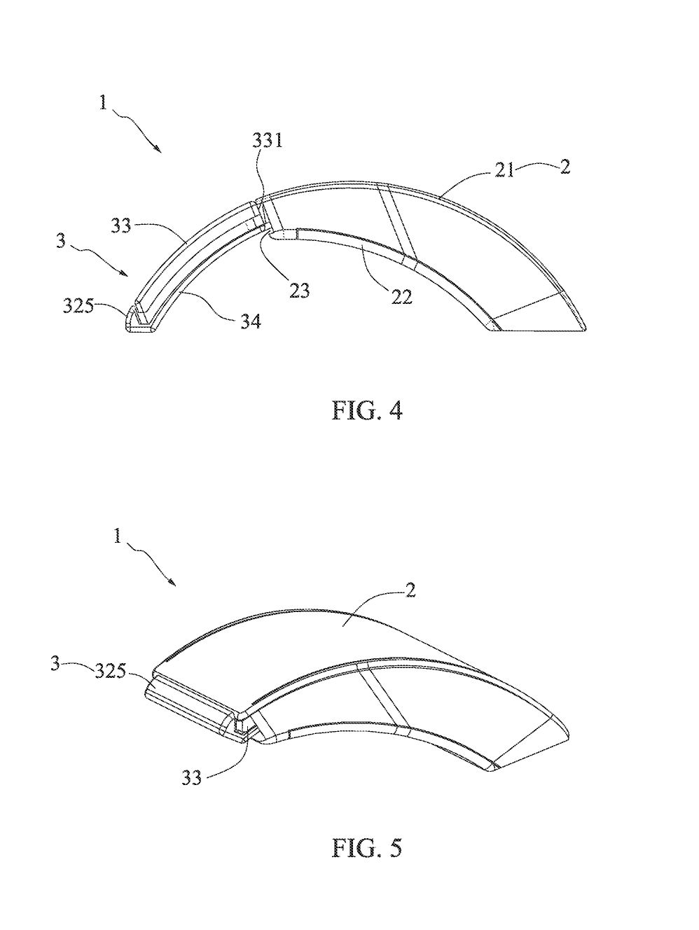

Referring to FIGS. 1 and 3 showing a preferable embodiment of the present invention, a mouse structure 1 of present invention comprises a housing 2, a sliding apparatus 3, and a resilient device 4. The housing 2 has upper and lower walls 21, 22, an internal space 20 defined between the upper and lower walls 21, 22, and an opening 23 communicating with the internal space 20. In this preferred embodiment, the upper and lower walls 21, 22 of the housing 2 are curved in cross section (as shown in FIGS. 1 and 4). However, the shape of the housing 2 is not limited thereby.

The sliding apparatus 3 is slidably disposed in the housing 2 and capable of sliding in and out of the internal space 20 of the housing 2 from the opening 23 (as shown in FIGS. 4 and 5), and is curved to correspond to the upper wall 21 of the housing 2. The sliding apparatus 3 comprises a base portion 31 and a reacting portion 32, wherein the reacting portion 32 integrally extends from one end of the base portion 31, and has a cover 33 and a bottom board 34. The bottom board 34 has an accommodating portion 320 defined thereon and a holding portion 325 formed on one end of the bottom board 34, the holding portion 325 being exposed to the housing 2. The cover 33 is located above and engageable with the bottom board 34 (as shown in FIG. 4), and has a position wall 331. Referring to FIG. 3, the bottom board 34 is further provided with two limiting portions 321, 322 located opposite to each other and four retaining walls 323, 324. The limiting portions 321, 322 and the retaining walls 323, 324 all protrude upwards of a surface of the bottom board 34 in the accommodating portion 320, and are arranged on peripheral portions of the bottom board 32, respectively. The limiting portion 321 is located at a front end of the bottom board 34 near the holding portion 325, and the retaining walls 323, 324 are located opposite to each other at left and right portions of the bottom board 34, respectively (as shown in FIG. 3).

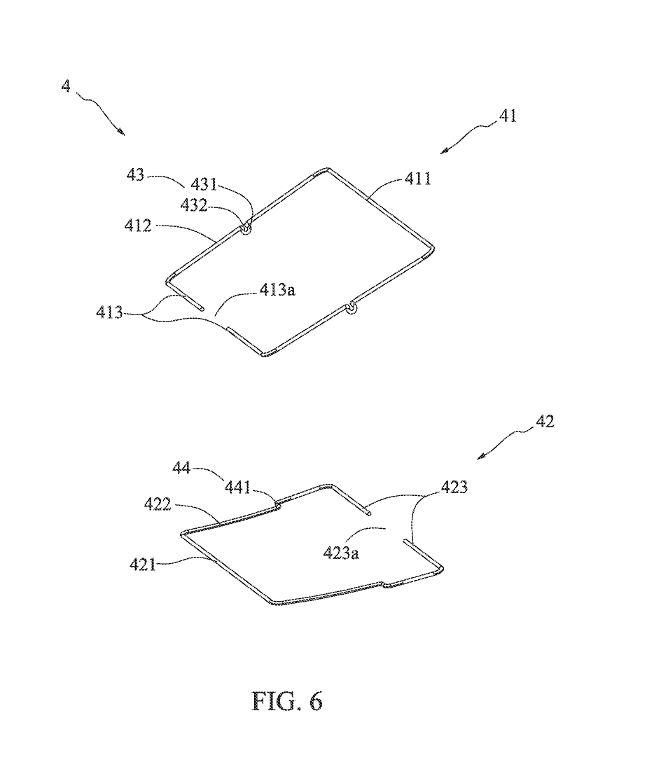

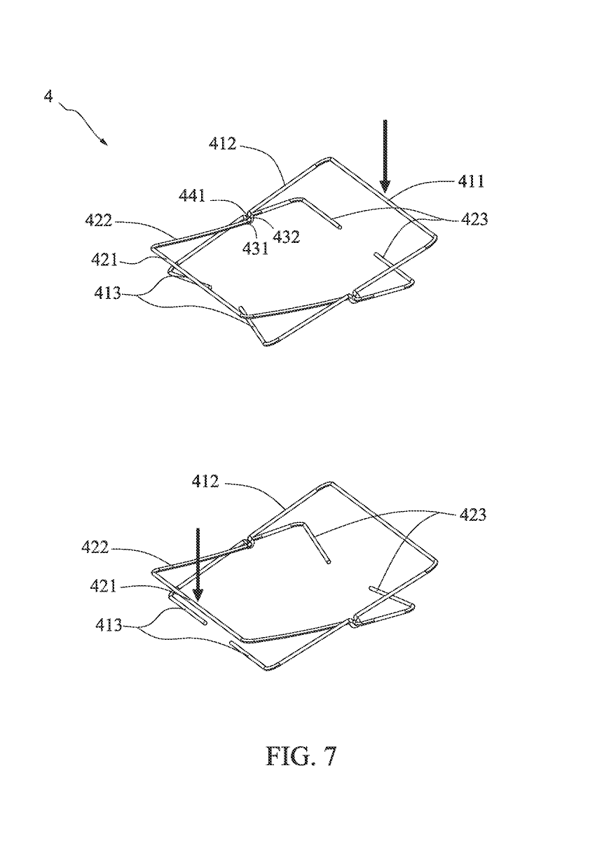

Referring to FIGS. 6 and 7 in combination with FIG. 3, the resilient device 4 is disposed on the accommodating portion 320 between the cover 33 and the bottom board 34. The resilient device 4 comprises a first spring element 41 and a second spring element 42 both having a frame-like shape and being substantially equal in size. The first and second spring elements 41, 42 have compressed portions 411, 421, two side portions 412, 422, and deforming portions 413, 423, respectively, wherein the compressed portions 411, 421 and the deforming portions 413, 423 are connected to the cover 33 and the bottom board 34, respectively, with fastening elements (not shown) or other regular fixing structures. The side portions 412, 422 are perpendicular to the compressed portions 411, 421 and the deforming portions 413, 423, respectively. The deforming portions 413, 423 are limited by the limiting portions 321, 322, respectively, and parts of the side portions 412, 422 of the first and second springs 41, 42 are propped against the retaining walls 323, 324, respectively. The side portions 412, 422 are tilted with respect to the cover 33 and the bottom board 34 towards different directions, respectively, inasmuch as the side portions 412 of the first spring element 41 are intersected with the side portions 422 of the second spring element 42. Furthermore, the deforming portions 413, 423 have gaps 413a, 423a (as shown in FIG. 6) formed on substantially middle parts of the deforming portions 413, 423 so as to divide the deforming portions 413, 423 for facilitating deformation when being stressed.

Particularly, each of the side portions 412 of the first spring element 41 forms a first pivot portion 43, and each of the side portions 422 of the second spring element 42 forms a second pivot portion 44. The first pivot portion 43 forms a pivoting slot 431 which has an arc shape and protrudes downwards from a substantially middle portion of the side portion 412 to form an opening 432. The second pivot portion 44 bends substantially perpendicularly from one portion of the side portion 422 to form a shaft 441 (as shown in FIG. 6), which is pivotally disposed in the pivoting slot 431. A width of the opening 432 is slightly smaller than a width of the shaft 441, so that the shaft 441 can be jammed into the pivoting slot 431 from the opening 432 and is effectively retained in the pivoting slot 431. In this manner, the first and second spring elements 41, 42 support each other with the first and second pivot portions 43, 44.

Referring to FIGS. 1 and 2 in combination with FIG. 7, when the sliding apparatus 3 is in a closed state, both the base portion 31 and the reacting portion 32 are in the internal space 20, wherein the cover 33 is retained by the upper wall 21 of the housing 3 in the internal space 20 (as shown in FIG. 5), and compress the compressed portions 411, 421 of the first and second spring elements 41, 42. Meanwhile, the deforming portions 413, 423 are stressed and deformed to bend inwards of the accommodating portion 320 (as shown in FIG. 2).

When the mouse structure 1 of the present invention is to be used, pull forwards the holding portion 325 to allow the sliding apparatus 3 to move out of the housing 2 from the opening 23. Therefore, the cover 33 is not retained by the housing 2 and is pushed outwards by the first and second spring elements 41, 42, whereby the position wall 331 is propped against the upper wall 21 of the housing 2, and the deforming portions 413, 423 return to their original shape and are limited by the limiting portions 321, 322. Accordingly, the sliding apparatus 3 is in an open state, and upper surface of the cover 33 is in alignment with the upper wall 21 of the housing 2 and retains no elevation difference with the upper wall 21 (as shown in FIG. 4).

Likewise, when the mouse structure 1 is to be returned to the close state, it is only need to slightly press the cover 33 and push the holding portion 325 to move into the housing 2. In particular, because the first and second spring elements 41, 42 are pivotally connected with each other through the first and second pivot portions 43, 44, the first and second spring elements 41, 42 act in conjunction with each other. Consequently, whatever portion of the cover 3 is compressed, the first and second spring elements 41, 42 pivot on the first and second pivot portions 43, 44, and concurrently move downwards, whereby the whole cover 33 moves in balance towards the bottom board 34 in conjunction with the first and second spring elements 41, 42. Therefore, the sliding apparatus 3 is capable of smoothly moving into the internal space 20 of the housing 2.

Accordingly, the mouse structure 1 of the present invention utilizes the cooperation of the first and second spring elements 41, 42, the bottom board 34, and the cover 33 to automatically position the cover 33 in place with no elevation difference retained with the upper wall 21 of the housing 2 when the reacting portion 32 moves out of the housing 2 in the open state. Furthermore the sliding apparatus 3 is capable of moving back to the closed state smoothly and quickly. Hence, the mouse structure 1 of the present invention is not only retractable to reduce the physical size, but also easy and efficiently to be positioned in place in either the open or closed state.

It is understood that the invention may be embodied in other forms within the scope of the claims. Thus the present examples and embodiments are to be considered in all respects as illustrative, and not restrictive, of the invention defined by the claims.

What is claimed is:

1. A mouse structure, comprising:
a housing having upper and lower walls, an internal space defined between the upper and lower walls, and an opening communicating with the internal space;
a sliding apparatus slidably disposed in the housing and capable of sliding in and out of the housing from the opening, the sliding apparatus comprising a base portion and a reacting portion, the reacting portion having a cover and a bottom board, the cover being engageable with the bottom board and having a position wall; and
a resilient device connected with and disposed between the cover and the bottom board;
wherein when the sliding apparatus is in a closed state, the cover is retained by the upper wall of the housing in the internal space, and the resilient device is compressed and deformed by the cover, while the reacting portion of the sliding apparatus moves out of the housing, the resilient device is not compressed, and the cover is pushed outwards by the resilient device, whereby the position wall of the cover is propped against the upper wall of the housing, and the sliding apparatus is in an open state.

2. The mouse structure of claim 1, wherein the resilient device comprises at least first and second spring elements, each of the first and second spring elements has a compressed portion, two side portions, and a deforming portion, the compressed portion is connected to the cover, the deforming portion is connected to the bottom board, each of the side portions of the first spring element forms a first pivot portion, each of the side portions of the second spring element forms a second pivot portion, and the first and second pivot portions pivotally connect with each other.

3. The mouse structure of claim 2, wherein the side portions of the first and second spring elements are tilted with respect to the cover and the bottom board, respectively, and the side portions of the first spring element are intersected with the side portions of the second spring element through the first and second pivot portions.

4. The mouse structure of claim 2, wherein the bottom board has at least two limiting portions located opposite to each other, and at least two retaining walls located opposite to each other, the deforming portions of the first and second springs are limited by the limiting portions, respectively, and the side portions of the first and second springs are propped against the retaining walls, respectively.

5. The mouse structure of claim 2, wherein the first pivot portion has a pivoting slot forming an opening thereon, and the second pivot portion has a shaft rotatably disposed in the pivoting slot.

6. The mouse structure of claim 5, wherein a width of the opening of the pivoting slot is smaller than a width of the shaft.

7. The mouse structure of claim 1, wherein a holding portion is formed on one end of the sliding apparatus and is exposed to the housing.

8. The mouse structure of claim 1, wherein when the sliding apparatus is in the open state, an upper surface of the cover is in alignment with the upper wall of the housing and retains no elevation difference with the upper wall of the housing.

9. The mouse structure of claim 2, wherein the deforming portion has a gap formed on a substantially middle part of the deforming portion so as to divide the deforming portion.
